(19) United States
(12) Patent Application Publication
(10) Pub. No.: US 2025/0362520 A1
(43) Pub. Date: Nov. 27, 2025

(54) LIGHT COMBINING MODULE

(71) Applicant: GUANGZHOU LUXVISIONS INNOVATION TECHNOLOGY LIMITED, Guangzhou City (CN)

(72) Inventors: Cheng-Te TSENG, Guangzhou City (CN); Yung-Chou CHEN, Guangzhou City (CN); Chuan-Hui LIU, Guangzhou City (CN)

(21) Appl. No.: 19/007,455

(22) Filed: Dec. 31, 2024

(30) Foreign Application Priority Data
May 21, 2024 (CN) 202410631722.0

(51) Int. Cl. G02B 27/12; G03B 21/16

(52) U.S. Cl. CPC G02B 27/126; G03B 21/16

(57) ABSTRACT

A light combining module includes: a positioning component, including a base and a cover body connected to the base; a light combining prism, sandwiched between the base and the cover body; and a light source component, attached to the positioning component and including a panel frame and a light source panel, the panel frame including a first surface facing the positioning component, and the light source panel including a light-emitting surface facing the positioning component. The first surface and the light-emitting surface are substantially coplanar.

### BACKGROUND OF THE DISCLOSURE

### Technical Field

The present disclosure relates to a light combining module, which is applied in a projector system.

### Description of Related Art

Projection technology is a technology that projects images onto a flat surface or space. According to the optical mechanism inside the projector, projectors may be divided into transmissive projectors and reflective projectors. Common technologies for transmissive projectors are liquid crystal display (LCD) projectors, and common technologies for reflective projectors are digital light processing (DLP) projectors and liquid crystal on silicon (LCOS) projectors. These types of projectors may produce images through a single-chip digital image or a three-chip digital image. The three-chip digital imaging needs to align a red light image, a green light image, and a blue light image to combine imaging. When the red light image, the green light image, and the blue light image are not properly aligned, the image may be blurred, color cast, overlapped, resolution reduced, or even impossible to image. Therefore, the three-chip digital image has higher requirements for mechanical tolerances and has higher calibration accuracy during manufacturing.

The calibration steps for a general three-chip imaging projector are setting the green image as the benchmark and adjusting an optical axis and a position for each of the red light image and blue light image to align with the green light image through a multi-axis positioner, for example, adjusting a focal length for each of images to be combined, a tilt angle of optical axis, a position of optical axis, a rotation angle of optical axis. The structural design of these types of projectors makes the calibration step difficult during manufacturing. For example, it is difficult to align the red light image, the green light image, and the blue light image on the multi-axis positioner with the reference planes of a light combining prism. Moreover, the assembly and positioning of this projector require a high degree of precision. Therefore, the variation during adjustment is large and the time required is long making manufacturing and assembly efficiency be low. In view of this, how to design a light combining module so that the structure of the light combining module may directly align the position for each of the red light image, the green light image, and the blue light image with the reference planes of the light combining prism to simplify the calibration steps when manufacturing projectors is one of the current problems that need to be solved.

### SUMMARY OF THE DISCLOSURE

The present disclosure provides a light combining module which may directly align the position for each of the red light image, the green light image, and the blue light image with the reference planes of a light combining prism to simplify the calibration steps when manufacturing projectors.

The present disclosure provides a light combining module, including: a positioning component, including a base and a cover body connected to the base; a light combining prism, sandwiched between the base and the cover body; and a light source component, attached to the positioning component and including a panel frame and a light source panel, the panel frame including a first surface facing the positioning component, and the light source panel including a light-emitting surface facing the positioning component, wherein the first surface and the light-emitting surface are substantially coplanar.

In some embodiments, at least three surfaces of the light combining prism abut against and are positioned at the base.

In some embodiments, six inner supporting surfaces and four openings are defined by the base and the cover body, the six inner supporting surfaces abut against four side surfaces, an upper surface, and a lower surface of the light combining prism.

In some embodiments, the base includes: three of the inner supporting surfaces, disposed adjacently and vertically to one another, and two of the three inner supporting surfaces respectively including an opening; the cover body includes: other three of the inner supporting surfaces, disposed adjacently and vertically to one another, and two of the three inner supporting surfaces respectively including an opening; the four side surfaces, the upper surface, and the lower surface of the light combining prism are sandwiched between the three inner supporting surfaces of the base and the three inner supporting surfaces of the cover body; a plurality of openings of the two of the three inner supporting surfaces of the base are disposed corresponding to two of four side surfaces of the light combining prism; a plurality of openings of the two of the three inner supporting surfaces of the cover body are disposed corresponding to other two of the four side surfaces of the light combining prism.

In some embodiments, the light source component includes: a heat dissipation layer, attached to the light source panel of the light source component; and a heat sink, attached to the heat dissipation layer and locked on the panel frame.

In some embodiments, the light source panel is a self-illuminating panel.

In some embodiments, the light combining module, further including: a first elastic element, disposed on the panel frame; and a light source component fixing cover, wherein the panel frame and the first elastic element are sandwiched between the light source component fixing cover and the positioning component.

In some embodiments, the light source component fixing cover includes: a second elastic element, disposed on a first frame edge of the light source component fixing cover; a third elastic element, disposed on a second frame edge of the light source component fixing cover, wherein the second frame edge is adjacent to the first frame edge; a plurality of first screws, disposed on a third frame edge of the light source component fixing cover, wherein the third frame edge is located opposite to the first frame edge; and a plurality of second screws, disposed on a fourth frame edge of the light source component fixing cover, wherein the fourth frame edge is located opposite to the second frame edge.

In some embodiments, a maximum static friction force between the first elastic element and the light source component fixing cover is less than a maximum static friction force between the first elastic element and the panel frame.

The present disclosure provides a light combining module, including: a positioning component, including a base, a cover body connected to the base, and a placement space defined between the base and the cover body; a light combining prism, disposed on the placement space and abutting against and positioned at the base; and a light source component, attached to the positioning component and including a panel frame and a light source panel, the panel frame including a first surface facing the positioning component, and the light source panel including a light-emitting surface facing the positioning component, wherein the first surface and the light-emitting surface are substantially coplanar.

In some embodiments, the base at least includes: three sides, the sides define a positioning point, and the light combining prism is abutting against and positioned at the positioning point.

In some embodiments, six inner supporting surfaces and four openings are defined by the base and the cover body, the six inner supporting surfaces abut against four side surfaces, an upper surface, and a lower surface of the light combining prism.

In some embodiments, the base includes: three of the inner supporting surfaces, disposed adjacently and vertically to one another, and two of the three inner supporting surfaces respectively including an opening; the cover body includes: other three of the inner supporting surfaces, disposed adjacently and vertically to one another, and two of the three inner supporting surfaces respectively including an opening; the four side surfaces, the upper surface, and the lower surface of the light combining prism are sandwiched between the three inner supporting surfaces of the base and the three inner supporting surfaces of the cover body; a plurality of openings of the two of the three inner supporting surfaces of the base are disposed corresponding to two of four side surfaces of the light combining prism; a plurality of openings of the two of the three inner supporting surfaces of the cover body are disposed corresponding to other two of the four side surfaces of the light combining prism.

In some embodiments, the light source component includes: a heat dissipation layer, attached to the light source panel of the light source component; and a heat sink, attached to the heat dissipation layer and locked on the panel frame.

In some embodiments, the light source panel is a self-illuminating panel.

In some embodiments, the light combining module, further including: a first elastic element, disposed on the panel frame; and a light source component fixing cover, wherein the panel frame and the first elastic element are sandwiched between the light source component fixing cover and the positioning component.

In some embodiments, the light source component fixing cover includes: a second elastic element, disposed on a first frame edge of the light source component fixing cover; a third elastic element, disposed on a second frame edge of the light source component fixing cover, wherein the second frame edge is adjacent to the first frame edge; a plurality of first screws, disposed on a third frame edge of the light source component fixing cover, wherein the third frame edge is located opposite to the first frame edge; and a plurality of second screws, disposed on a fourth frame edge of the light source component fixing cover, wherein the fourth frame edge is located opposite to the second frame edge.

In some embodiments, a maximum static friction force between the first elastic element and the light source component fixing cover is less than a maximum static friction force between the first elastic element and the panel frame.

In summary, the positioning component of the light combining module of the present disclosure may position the light combining prism in the up and down, left and right, and front and back directions and prevent sliding. The base and the cover body have three vertical the inner supporting surfaces and respectively clamp and position the light combining prism in the up and down, left and right, and front and back directions and prevent sliding. The light combining prism may be quickly aligned during manufacturing and assembly to make manufacturing and assembly faster. The light source panel may face the light combining prism, and the time spent to adjust and calibrate the angle between a normal vector of the light-emitting surface and the normal vector of the light combining prism may be saved. The light combining prism may output the red light image, the green light image, and the blue light image from the fourth side surface of the light combining prism. Three of the openings of the positioning component may transmit the red light image, the green light image, and the blue light image to the light combining prism, and the other one of the openings may output the combined light image through the light combining prism. In other words, the light combining module may directly align the position for each of the red light image, the green light image, and the blue light image with the reference planes of the light combining prism to simplify the calibration steps when manufacturing projectors. The monolithic piece constructed of the heat sink and the panel frame may accelerate heat dissipation and make the heat sink and the panel frame stable and easy to assemble. The light source panel may be the self-illuminating panel. When the light source component and the heat sink are constructed as a monolithic piece, the heat sink may not block the backlight that may come from some distance behind the panel. The light source component fixing cover may fix the panel frame. One of the dimensions of the light source component of the light combining module A of the present disclosure may be adjusted and the light source component of the light combining module of the present disclosure may be slightly rotated, under the condition of the panel frame fixed by the light source component fixing cover. Another of the dimensions of the light source component may be adjusted and the light source component may also be slightly rotated, through a second screw and the third elastic element. Moreover, through the design of the friction condition, the light source component may be pushed easily. When assembled, the positioning component and the panel frame are positioned by directly facing and contacting each other and achieving the positioning in one dimension and the panel frame may be adjusted through a first screw and the second screw to achieve the positioning of the remaining two dimensions to simplify the calibration steps of manufacturing projectors. A combined light image output by the light combining prism is projected onto a surface at a specific distance to produce a color visual image that may be viewed.

### BRIEF DESCRIPTION OF THE DRAWINGS

FIG. 1A is a schematic diagram of the light combining module in accordance with a first embodiment of the present disclosure.

FIG. 1B is a structurally exploded diagram of the light combining module in accordance with a first embodiment of the present disclosure.

FIG. 2 is a structurally exploded diagram of the positioning component and the light combining prism in accordance with the present disclosure.

FIG. 3A is a schematic diagram of the light source component in accordance with the present disclosure.

FIG. 3B is a schematic diagram of a variation of the light source component in accordance with the present disclosure.

FIG. 3C is a structurally exploded diagram of a variation of the light source component in accordance with the present disclosure.

FIG. 4A is a schematic diagram of the light combining module in accordance with a second embodiment of the present disclosure.

FIG. 4B is a structurally exploded diagram of the light combining module in accordance with a second embodiment of the present disclosure.

FIG. 5A is a schematic diagram of an application of the light combining module in accordance with the present disclosure.

FIG. 5B is a structurally exploded diagram of an application of the light combining module in accordance with the present disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

As used in the present disclosure, terms such as “first”, “second”, “third” and “fourth” are employed to describe various elements, components, regions, layers, and/or parts. These terms should not be construed as limitations on the mentioned elements, components, regions, layers, and/or parts. Instead, they are used merely for distinguishing one element, component, region, layer, or part from another. Unless explicitly indicated in the context, the usage of terms such as “first”, “second”, “third” and “fourth” does not imply any specific sequence or order.

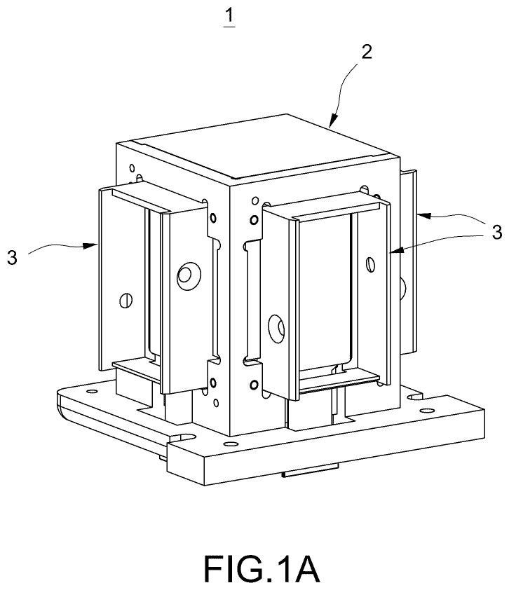

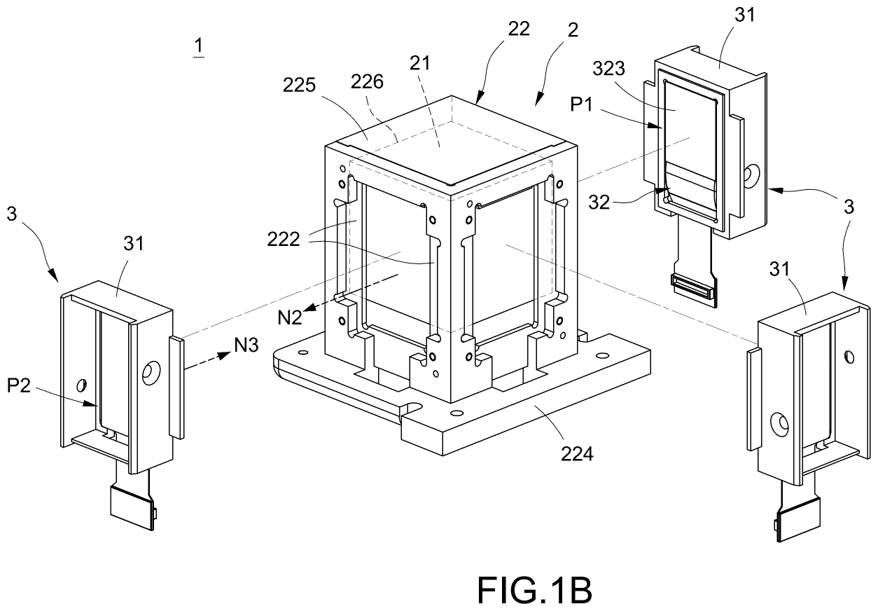

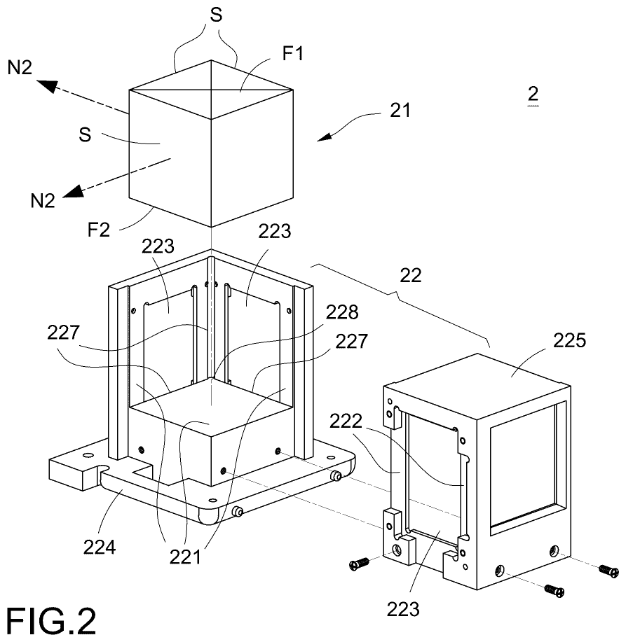

FIG. 1A is a schematic diagram of the light combining module in accordance with a first embodiment of the present disclosure. FIG. 1B is a structurally exploded diagram of the light combining module in accordance with a first embodiment of the present disclosure. FIG. 2 is a structurally exploded diagram of the positioning component and the light combining prism in accordance with the present disclosure. Please refer to FIG. 1A, FIG. 1B and FIG. 2. A light combining module 1 of this embodiment includes a positioning component 22, a light combining prism 21, and a light source component 3. The positioning component 22 includes a base 224 and a cover body 225 connected to the base 224. The base 224 and the cover body 225 are configured to position the light combining prism 21. The light combining prism 21 is, for example, a hexahedron. The base 224 and the cover body 225 may have, for example, six faces in total and sandwiched the light combining prism 21. For example, the base 224 has one side, and the cover body 225 has five sides; the base 224 has two sides, the cover body 225 has four sides; the base 224 has three sides, the cover body 225 has three sides; the base 224 has four sides, the cover body 225 has two sides; or the base 224 has five sides, the cover body 225 has one side, to position the light combining prism 21 in the up and down, left and right, and front and back directions, and prevent sliding. In other words, the base 224 and the cover body 225 are connected to define a placement space 226. The placement space 226 may abut against and position the light combining prism 21 within the placement space 226.

The light combining prism 21 is sandwiched between the base 224 and the cover body 225. The light combining prism 21 may be, for example, a rectangular column, a square column, or a cube, here is not intended to be limiting. The light combining prism 21 may have, for example, a blue light reflecting surface disposed on a diagonal section of the light combining prism 21 and reflecting blue light and transmitting other light and a red light reflecting surface disposed on another diagonal section of the light combining prism 21 and reflecting red light and transmitting other light. Take the light combining prism 21 in a square column shape as an example, these two surfaces, for example, may be disposed on the diagonal section of the square column. When viewed from an upper surface F1, the projection of these two surfaces may be located at the diagonal of the upper surface F1 square. As a result, when the red light image, the green light image, and the blue light image are disposed corresponding on three side surfaces S of the light combining prism 21, the red light image, the green light image, and the blue light image may be output from a fourth side surface S of the light combining prism 21. The light combining prism 21 is sandwiched in, for example, the placement space 226, which is defined by the base 224 and the cover body 225 connected.

The light source component 3 is attached to the positioning component 22 and includes a panel frame 31 and a light source panel 32, the panel frame 31 includes a first surface P1 facing the positioning component 22, and the light source panel 32 includes a light-emitting surface 323 facing the positioning component 22, wherein the first surface P1 and the light-emitting surface 323 are substantially coplanar. The panel frame 31 may be, for example, directly attached on an outer supporting surfaces 222 of the positioning component 22 through the first surface P1 or another surface to make the first surface P1 face the positioning component 22. The light source panel 32 may be a self-illuminating panel, for example, a micro light-emitting diode panel; or a non-self-illuminating panel, for example, a liquid-crystal display (LCD) panel, the backlight of the LCD panel comes from another light source at a certain distance behind the LCD panel. For example, the light source panel 32 may emit a red light image, such as directly through a red micro light-emitting diode, through a red backlight penetrating the LCD panel, or through a white backlight penetrating the LCD panel with a red filter. The light source panel 32 may be, for example, directly attached on a second surface P2 of the panel frame 31 through the light-emitting surface 323 or another surface to make the light-emitting surface 323 face the positioning component 22. The first surface P1 of the panel frame 31 and the light-emitting surface 323 of the light source panel 32 are substantially coplanar. As a result, under the condition of the panel frame 31 and the positioning component 22 are positioned, the light source panel 32 and the positioning component 22 are also positioned. In other words, under the condition of the panel frame 31 and the positioning component 22 are positioned, the light-emitting surface 323 of the light source panel 32 faces the positioning component 22.

Since the positioning component 22, the panel frame 31 and the light source panel 32 have tolerances, the tolerances may accumulate when the three are assembled together. In the design stage, tolerance accumulation analysis and calculation may be used to determine that the tolerance meets the optical requirements of the projector design. Here is not intended to be limiting. Tolerance accumulation analysis and calculation may be used to determine that the angle between a normal vector N3 of the light-emitting surface 323 and the normal vector N2 of the light combining prism 21 is less than the optical limiting angle to avoid image blur. Since the light source panel 32 faces the positioning component 22 through the panel frame 31, the positioning component 22 positions the light combining prism 21, the light source panel 32 may face the light combining prism 21. As a result, the time spent to adjust and calibrate the angle between the normal vector N3 of the light-emitting surface 323 and the normal vector N2 of the light combining prism 21 may be saved. In other words, the surface of the light combining prism 21 is the reference plane of the structure, and the positioning component 22 and the panel frame 31 may be positioned by directly facing and contacting each other.

In some embodiments, the light source panel 32 of the red light image, the light source panel 32 of the green light image, and the light source panel 32 of the blue light image may face the different sides of the positioning component 22 through the panel frame 31 and the positioning component 22 may position the light combining prism 21. As a result, the red light image, the green light image, and the blue light image may be output from a fourth side surface S of the light combining prism 21.

In some embodiments, the assembled structure of the positioning component 22 and the light combining prism 21 may be called a light combining component 2 or called an optomechanical main body.

It is worth mentioning that, in the embodiment, at least three surfaces of the light combining prism 21 abut against and are positioned at the base 224. As a result, the light combining prism 21 is positioned at the base 224, here is not intended to be limiting. In some embodiments, the light combining prism 21 may have, for example, three surfaces, four surfaces, or five surfaces to abut against and be positioned at the base 224.

Further, in the embodiment, six inner supporting surfaces 221 and four openings 223 are defined by the base 224 and the cover body 225, the six inner supporting surfaces 221 abut against four side surfaces S, an upper surface F1, and a lower surface F2 of the light combining prism 21. The base 224 has three sides and the cover body 225 has three sides to position the light combining prism 21 in the up and down, left and right, and front and back directions and prevent sliding. Here is not intended to be limiting. In some embodiments, for example, the base 224 has one side and the cover body 225 has five sides, the base 224 has two sides and the cover body 225 has four sides, the base 224 has four sides and the cover body 225 has two sides, or the base 224 has five sides and the cover body 225 has one side.

Moreover, in the embodiment, the base 224 has two openings 223 and the cover body 225 has two openings 223. As a result, the light combining prism 21 is positioned between the base 224 and the cover body 225. Three of the openings 223 may transmit the red light image, the green light image, and the blue light image to the light combining prism 21, and the other one of the openings 223 may output the combined light image through the light combining prism 21, here is not intended to be limiting. In some embodiment, for example, the cover body 225 has four openings 223, the base 224 has one opening 223 and the cover body 225 has three openings 223, the base 224 has three openings 223, and the cover body 225 has one opening 223, or the base 224 has four openings 223. The four openings 223 respectively correspond to the four side surfaces S of the light combining prism 21.

Moreover, in the embodiment, the base 224 includes three of the inner supporting surfaces 221 is disposed adjacently and vertically to one another, and two of the three inner supporting surfaces 221 respectively include an opening 223. The cover body 225 includes other three of the inner supporting surfaces 221 are disposed adjacently and vertically to one another, and two of the three inner supporting surfaces 221 respectively include an opening 223. The four side surfaces S, the upper surface F1, and the lower surface F2 of the light combining prism 21 are sandwiched between the three inner supporting surfaces 221 of the base 224 and the three inner supporting surfaces 221 of the cover body 225. A plurality of openings 223 of the two of the three inner supporting surfaces 221 of the base 224 are disposed corresponding to two of four side surfaces S of the light combining prism 21. A plurality of openings 223 of the two of the three inner supporting surfaces 221 of the cover body 225 are disposed corresponding to other two of the four side surfaces S of the light combining prism 21. In the embodiment, the light combining prism 21 is in a square column shape, here is not intended to be limiting. In some embodiments, the light combining prism 21 may be, for example, in the shape of a rectangular column or a cube whose adjacent surfaces are perpendicular to one another. The three vertical inner supporting surfaces 221 of the base 224 may attach the light combining prism 21 whose adjacent surfaces are perpendicular to one another. The surface without an opening 223 of the base 224 may be arranged at the bottom (the bottom in FIG. 2). This surface faces the desktop during assembly to make the base 224 easy to assemble and test on the desktop, workbench, or inside the projector case. The surfaces of the base 224 with the openings 223 may be arranged on the sides to facilitate assembly and testing. The three vertical inner supporting surfaces 221 of the cover body 225 may attach the light combining prism 21 whose adjacent surfaces are perpendicular to one another. The surface without an opening 223 of the cover body 225 may be arranged at the top (the top in FIG. 2). As a result, the cover body 225 is easy to assemble and test on the desktop, workbench, or inside the projector case. The surfaces of the cover body 225 with the openings 223 may be arranged on the sides to facilitate assembly and testing. As a result, the light combining prism 21 is positioned between the base 224 and the cover body 225. Three of the openings 223 may transmit the red light image, the green light image, and the blue light image to the light combining prism 21, and the other one of the openings 223 may output the combined light image through the light combining prism 21.

In the embodiment, the base 224 at least includes three sides 227, the sides 227 define a positioning point 228, and the light combining prism 21 is abutting against and positioned at the positioning point 228. In the embodiment, three of the sides of the light combining prism 21 abut against and is positioned at three of the sides 227 of the base 224, here is not intended to be limiting. In other embodiments, for example, four of the sides of the light combining prism 21 abut against and are positioned at four of the sides 227 of the base 224, or five of the sides of the light combining prism 21 abut against and are positioned at five of the sides 227 of the base 224. The point defined by three of the sides 227 of the light combining prism 21 abuts against and is positioned at the positioning point 228. As a result, the light combining prism 21 is positioned at the base 224.

In summary, the base 224 and the cover body 225 of the positioning component 22 of the light combining module 1 of the present disclosure respectively have three vertical the inner supporting surfaces 221 and respectively clamp and position the light combining prism 21 in the up and down, left and right, and front and back directions and prevent sliding. The light combining prism 21 may be quickly aligned during manufacturing and assembly to make manufacturing and assembly faster. Since the light source panel 32 may face the light combining prism 21, the time spent to adjust and calibrate the angle between the normal vector N3 of the light-emitting surface 323 and the normal vector N2 of the light combining prism 21 may be saved. Three of the openings 223 of the positioning component 22 may transmit the red light image, the green light image, and the blue light image to the light combining prism 21, and output from the fourth side surface S of the positioning component 22 through the other one of the openings 223 of the positioning component 22. In other words, the light combining module 1 may directly align the position for each of the red light image, the green light image, and the blue light image with the reference planes of the light combining prism 21 to simplify the calibration steps when manufacturing projectors.

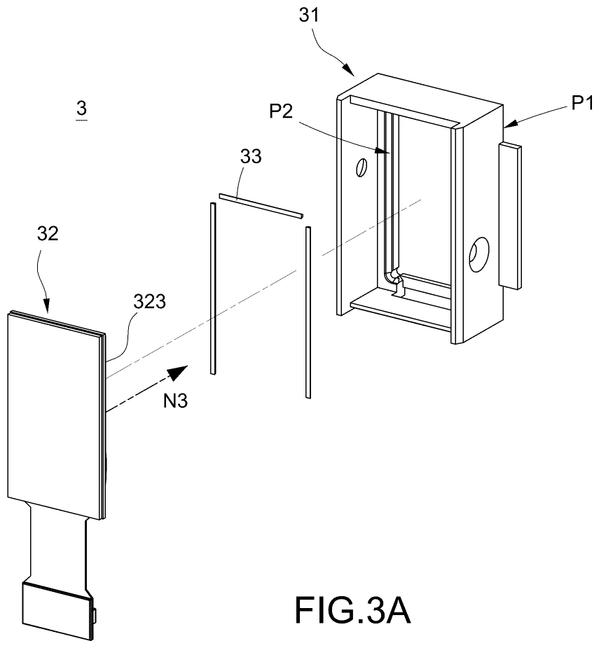

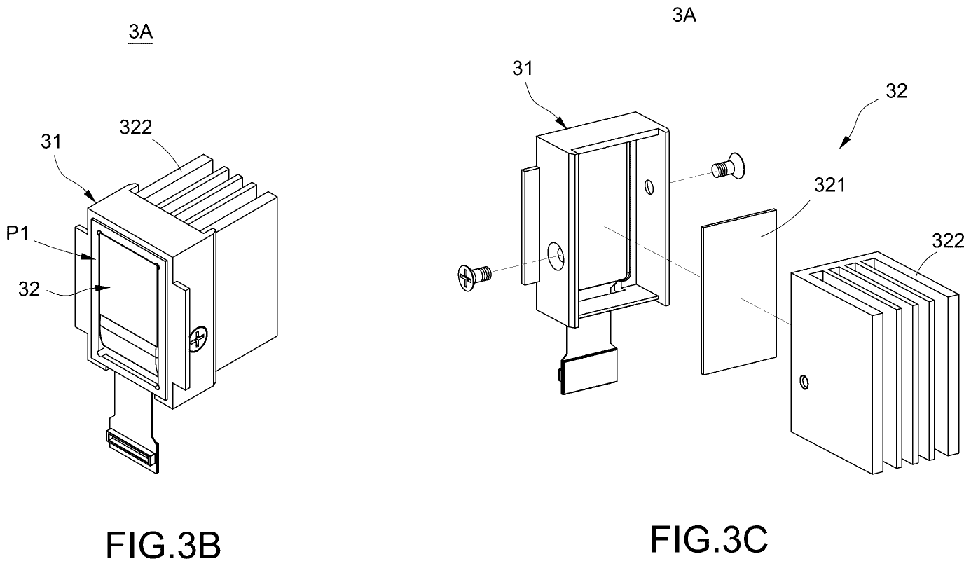

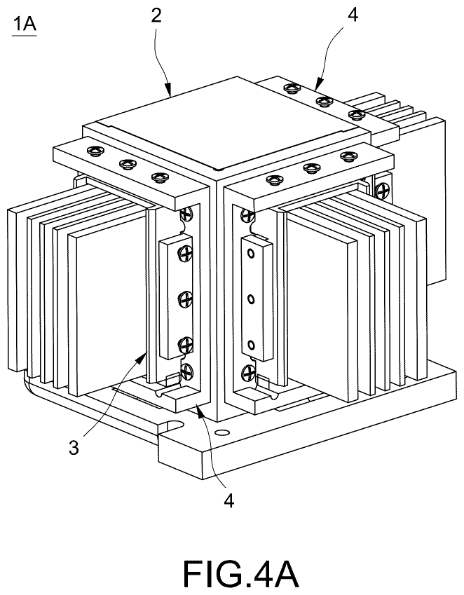

FIG. 3A is a schematic diagram of the light source component in accordance with the present disclosure. FIG. 3A is a schematic diagram of the light source component in accordance with the present disclosure. FIG. 3C is a structurally exploded diagram of a variation of the light source component in accordance with the present disclosure. Please refer to FIG. 3A, FIG. 3B and FIG. 3C. In some embodiments, a light source component 3A includes a heat dissipation layer 321 and a heat sink 322. The heat dissipation layer 321 is attached to the light source panel 32 of the light source component 3A. The heat sink 322 is attached to the heat dissipation layer 321 and locked on the panel frame 31. The heat dissipation layer 321 may be, for example, a thermal conductive gel. For example, the heat dissipation layer 321 may be applied, for example, uniformly or non-uniformly on the light source panel 32 to make the heat sink 322 be attached to the light source panel 32. As a result, the waste heat of the light source panel 32 may pass through the heat dissipation layer 321 and the heat sink 322 to the air or other media through heat conduction, heat convection, and heat radiation to free from the problems of overheating of the light source panel 32. Moreover, the light source component 3A and the heat sink 322 may be constructed as a monolithic piece to make assembly easier. In some embodiments, the heat sink 322 may be locked to the panel frame 31 through screws to make the monolithic piece constructed by the light source component 3A and the heat sink 322 be more securely fixed to the panel frame 31.

In some embodiments, the contact area between the light source panel 32 and the panel frame 31 may be attached by, for example, an adhesive 33. The adhesive 33 may be, for example, an ultraviolet adhesive of low shrinkage to make the light source panel 32 and the panel frame 31 an integrated structure. The light source panel 32 may be a self-illuminating panel, for example, a micro light-emitting diode panel, an organic light-emitting diode panel, a liquid crystal panel with a side-light backlight module, and a liquid crystal panel with of straight down backlight module, here is not intended to be limiting. As a result, in some embodiments, when the light source component 3A and the heat sink 322 are constructed as a monolithic piece, the heat sink 322 may not block the backlight that may come from some distance behind the panel.

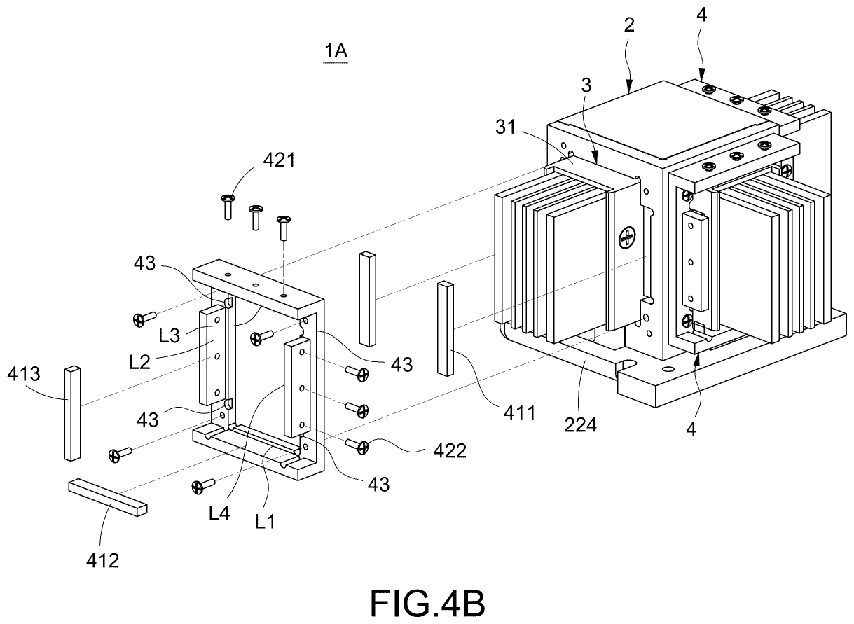

FIG. 4A is a schematic diagram of the light combining module in accordance with a second embodiment of the present disclosure. FIG. 4B is a structurally exploded diagram of the light combining module in accordance with a second embodiment of the present disclosure. Please refer to FIG. 2, FIG. 3A, FIG. 3C, FIG. 4A, and FIG. 4B, in the embodiment, the light combining module 1A further includes a first elastic element 411 and a light source component fixing cover 4, the first elastic element 411 is disposed on the panel frame 31. The first elastic element 411 is attached, for example, on both sides of the panel frame 31. The first elastic element 411 may have elastic. When the first elastic element 411 is compressed, the first elastic element 411 may provide a force in the opposite direction to the compressing direction. The first elastic element 411 may be, for example, an elastic body that obeys Hooke's law, here is not intended to be limiting. The first elastic element 411 may be, for example, a spring, an elastic foam, high-density elastic foam, or a poron. During assembly, the first elastic element 411 disposed on the panel frame 31 may be pressed by the light source component fixing cover 4, and the light source component fixing cover 4 is locked to the positioning component 22 through screws to make the light source component fixing cover 4 and the positioning component 22 sandwich the panel frame 31 and the first elastic element 411 to fix the panel frame 31, in other words, to fix the light source component 3.

In other embodiments, the panel frame 31 may also be attached to the positioning component 22 through adhesive.

In the embodiment, the light source component fixing cover 4 includes a second elastic element 412, a third elastic element 413, a first screw 421, and a second screw 422.

The second elastic element 412 is disposed on a first frame edge L1 of the light source component fixing cover 4. The first screw 421 is disposed on a third frame edge L3 of the light source component fixing cover 4, wherein the third frame edge L3 is located opposite to the first frame edge L1. The structure of the second elastic element 412 may be similar to the first elastic element 411, here is omitted for brevity. The light source component fixing cover 4 may be, for example, a rectangular frame or other polygonal frame, here is not intended to be limiting. The second elastic element 412 may be, for example, attached to the inside of the first frame edge L1. The third frame edge L3 may have threads, the first screw 421 may lock into and pass through the threads of the third frame edge L3. The first screw 421 may have, for example, one, two, three, or more than four screws. During calibration, the first screw 421 may contact the light source component 3A, and be adjusted, for example, the left and right direction of the light source component 3A. For example, when the first screw 421 is locked, the light source component 3A may be moved to the left and supported by the feedback elastic force of the second elastic element 412 and when the first screw 421 is loosened, the light source component 3A may be moved to the right and supported by the feedback elastic force of the second elastic element 412. As a result, one of the dimensions of the light source component 3A may be adjusted through the first screw 421 and the second elastic element 412. When the first screw 421 has more than two screws, the light source component 3A may also be slightly rotated to facilitate image adjustment. In the embodiment, the first screw 421 is locked and loosened by manual adjustment, here is not intended to be limiting. In other embodiments, the first screw 421 may be adjusted by an automated robotic arm.

A third elastic element 413 is disposed on a second frame edge L2 of the light source component fixing cover 4, wherein the second frame edge L2 is adjacent to the first frame edge L1. The screw 422 is disposed on a fourth frame edge L4 of the light source component fixing cover 4, wherein the fourth frame edge L4 is located opposite to the second frame edge L2. The structure of the third elastic element 413 may be similar to the first elastic element 411, here is omitted for brevity. The light source component fixing cover 4 may be, for example, a rectangular frame or other polygonal frame, here is not intended to be limiting. The third elastic element 413 may be, for example, attached to the inside of the second frame edge L2. The fourth frame edge L4 may have threads, and a second screw 422 may lock into and pass through the threads of the fourth frame edge L4. The second screw 422 may have, for example, one, two, three, or more than four screws. During calibration, the second screw 422 may contact the light source component 3A, and be adjusted, for example, the up and down direction of the light source component 3A. For example, when the second screw 422 is locked, the light source component 3A may be moved to the down and supported by the feedback elastic force of the third elastic element 413 and when the second screw 422 is loosened, the light source component 3A may be moved to the up and supported by the feedback elastic force of the third elastic element 413. As a result, another of the dimensions of the light source component 3A may be adjusted through the second screw 422 and the third elastic element 413. When the second screw 422 has more than two screws, the light source component 3A may also be slightly rotated to facilitate image adjustment. In the embodiment, the second screw 422 is locked and loosened by manual adjustment, here is not intended to be limiting. In other embodiments, the first screw 421 may be adjusted by an automated robotic arm.

In some embodiments, a maximum static friction force between the first elastic element 411 and the light source component fixing cover 4 is less than a maximum static friction force between the first elastic element 411 and the panel frame 31. The first elastic element 411 may be, for example, a high-density elastic foam with a smooth surface. When the first screw 421 or the second screw 422 is locked, a thrust force may be generated on the light source component 3A. Since the maximum static friction force between the first elastic element 411 of the light source component 3A and the light source component fixing cover 4 is small, and the light source component fixing cover 4 is locked on the positioning component 22, the light source component 3A may be pushed easily.

The light source panel 32 of the red light image, the light source panel 32 of the green light image, and the light source panel 32 of the blue light image may face the different sides of the positioning component 22 through the panel frame 31 and the positioning component 22 may position the light combining prism 21. As a result, the red light image, the green light image, and the blue light image may be output from a fourth side surface S of the light combining prism 21. The light source panel 32 of the red light image, the light source panel 32 of the green light image, and the light source panel 32 of the blue light image may achieve the assembly through manual or an automated robotic arm. For example, the light source panel 32 of the green light image may be used as a reference, and the light source panel 32 of the red light image and the light source panel 32 of the blue light image are calibrated to overlap and match with the projected image produced by the light source panel 32 of the green light image. The light source component 3A of the light source panel 32 of the green light image may be fixed through the light source component fixing cover 4. Since the light source panel 32 of the green light image is the reference plane, the position may be adjusted by skipping the first screw 421, the second screw 422, the second elastic element 412, and the third elastic element 413, here is not intended to be limiting. Moreover, the light source panel 32 of the red light image and the light source panel 32 of the blue light image may be fixed through the light source component fixing cover 4 and adjusted position through the first screw 421, the second screw 422, the second elastic element 412 and the third elastic element 413. The light source panel 32 of the red light image and the light source panel 32 of the blue light image are calibrated to overlap and match with the projected image produced by the light source panel 32 of the green light image to make the image clear. A hole 43 may be defined on the light source component fixing cover 4, the hole 43 may be injected by the adhesive 33. For example, the light source component fixing cover 4 and the light source component 3A are attached through an ultraviolet adhesive of low-shrinkage cured by ultraviolet light to enhance the tightness after positioning.

In other embodiments, the light source component 3 may not be fixed by the light source component fixing cover 4. For example, the panel frame 31 and the positioning component 22 are attached through the adhesive 33, or the panel frame 31 is locked to the positioning component 22 through the screws.

In summary, one of the dimensions of the light source component 3A of the light combining module 1A of the present disclosure may be adjusted and the light source component 3A of the light combining module 1A of the present disclosure may be slightly rotated, under the condition of the panel frame 31 fixed by the light source component fixing cover 4. Moreover, another of the dimensions of the light source component 3A may be adjusted and the light source component 3A may also be slightly rotated, through the second screw 422 and the third elastic element 413. Moreover, through the design of the friction condition, the light source component 3A may be pushed easily. When assembled, the positioning component 22 and the panel frame 31 are positioned by directly facing and contacting each other and achieving the positioning in one dimension and the panel frame 31 may be adjusted through the first screw 421 and the second screw 422 to achieve the positioning of the remaining two dimensions to simplify the calibration steps of manufacturing projectors.

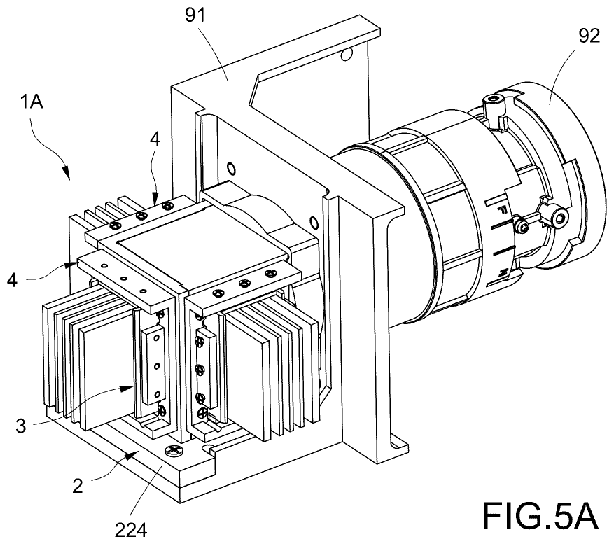

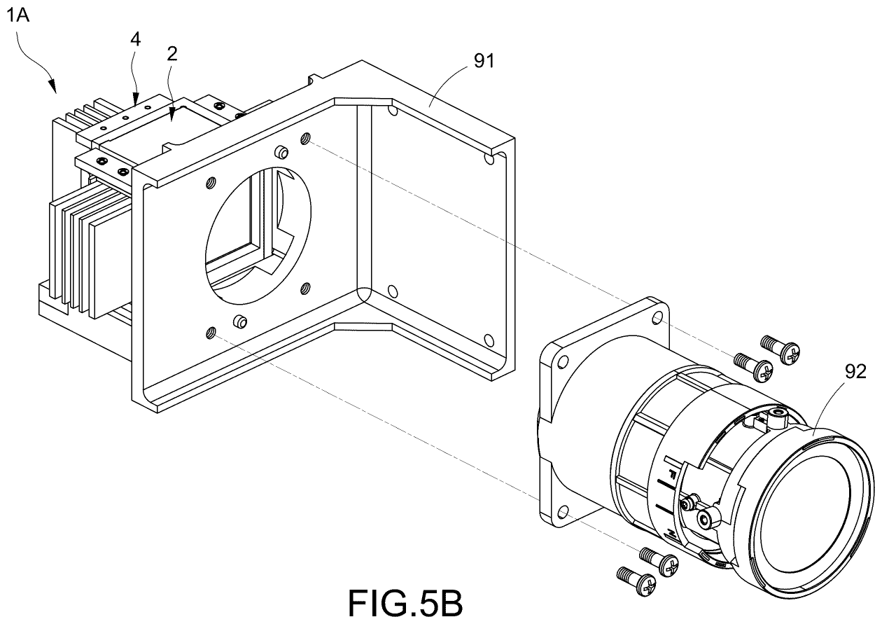

FIG. 5A is a schematic diagram of an application of the light combining module in accordance with the present disclosure. FIG. 5B is a structurally exploded diagram of an application of the light combining module in accordance with the present disclosure. Please refer to FIG. 1B, FIG. 5A, and FIG. 5B, the light combining module 1A of this embodiment may be further combined with a lens holder 91 and a lens component 92. The lens holder 91 is locked with the positioning component 22, and the lens component 92 is locked with the lens holder 91. For example, through a relative distance of a lens component 92 inside the lens component 92, an object distance, an image distance, and a focal length may be adjusted. Moreover, through the lens component 92, the dispersion aberration caused by the different refractive index of the red light, the green light, and the blue light may be corrected.

As a result, a combined light image output by the light combining prism 21 is projected onto a surface at a specific distance to produce a color visual image that may be viewed.

As used herein and not otherwise defined, the terms “substantially” and “approximately” are used to describe and account for small variations. When used in conjunction with an event or circumstance, the terms may refer to instances in which the event or circumstance occurs precisely as well as instances in which the event or circumstance occurs to a close approximation. For example, when used in conjunction with a numerical value, the terms may refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

While this disclosure has been described by means of specific embodiments, numerous modifications and variations may be made thereto by those skilled in the art without departing from the scope and spirit of this disclosure set forth in the claims.

What is claimed is:

1. A light combining module, comprising:
a positioning component, comprising a base and a cover body connected to the base;
a light combining prism, sandwiched between the base and the cover body; and
a light source component, attached to the positioning component and comprising a panel frame and a light source panel, the panel frame comprising a first surface facing the positioning component, and the light source panel comprising a light-emitting surface facing the positioning component, wherein the first surface and the light-emitting surface are substantially coplanar.

2. The light combining module of claim 1, wherein at least three surfaces of the light combining prism abut against and are positioned at the base.

3. The light combining module of claim 1, wherein six inner supporting surfaces and four openings are defined by the base and the cover body, the six inner supporting surfaces abut against four side surfaces, an upper surface, and a lower surface of the light combining prism.

4. The light combining module of claim 3, wherein the base comprises:
three of the inner supporting surfaces, disposed adjacently and vertically to one another, and two of the three inner supporting surfaces respectively comprising an opening;
the cover body comprises:
other three of the inner supporting surfaces, disposed adjacently and vertically to one another, and two of the three inner supporting surfaces respectively comprising an opening;
the four side surfaces, the upper surface, and the lower surface of the light combining prism are sandwiched between the three inner supporting surfaces of the base and the three inner supporting surfaces of the cover body;
a plurality of openings of the two of the three inner supporting surfaces of the base are disposed corresponding to two of four side surfaces of the light combining prism;
a plurality of openings of the two of the three inner supporting surfaces of the cover body are disposed corresponding to other two of the four side surfaces of the light combining prism.

5. The light combining module of claim 1, wherein the light source component comprises:
a heat dissipation layer, attached to the light source panel of the light source component; and
a heat sink, attached to the heat dissipation layer and locked on the panel frame.

6. The light combining module of claim 1, wherein the light source panel is a self-illuminating panel.

7. The light combining module of claim 1, further comprising:
a first elastic element, disposed on the panel frame; and
a light source component fixing cover, wherein the panel frame and the first elastic element are sandwiched between the light source component fixing cover and the positioning component.

8. The light combining module of claim 7, wherein the light source component fixing cover comprises:
a second elastic element, disposed on a first frame edge of the light source component fixing cover;
a third elastic element, disposed on a second frame edge of the light source component fixing cover, wherein the second frame edge is adjacent to the first frame edge;
a plurality of first screws, disposed on a third frame edge of the light source component fixing cover, wherein the third frame edge is located opposite to the first frame edge; and
a plurality of second screws, disposed on a fourth frame edge of the light source component fixing cover, wherein the fourth frame edge is located opposite to the second frame edge.

9. The light combining module of claim 8, wherein a maximum static friction force between the first elastic element and the light source component fixing cover is less than a maximum static friction force between the first elastic element and the panel frame.

10. A light combining module, comprising:
a positioning component, comprising a base, a cover body connected to the base, and a placement space defined between the base and the cover body;
a light combining prism, disposed on the placement space and abutting against and positioned at the base; and
a light source component, attached to the positioning component and comprising a panel frame and a light source panel, the panel frame comprising a first surface facing the positioning component, and the light source panel comprising a light-emitting surface facing the positioning component, wherein the first surface and the light-emitting surface are substantially coplanar.

11. The light combining module of claim 10, wherein the base at least comprises:
three sides, the sides define a positioning point, and the light combining prism is abutting against and positioned at the positioning point.

12. The light combining module of claim 10, wherein six inner supporting surfaces and four openings are defined by the base and the cover body, the six inner supporting surfaces abut against four side surfaces, an upper surface, and a lower surface of the light combining prism.

13. The light combining module of claim 12, wherein the base comprises:
three of the inner supporting surfaces, disposed adjacently and vertically to one another, and two of the three inner supporting surfaces respectively comprising an opening;
the cover body comprises:
other three of the inner supporting surfaces, disposed adjacently and vertically to one another, and two of the three inner supporting surfaces respectively comprising an opening;
the four side surfaces, the upper surface, and the lower surface of the light combining prism are sandwiched between the three inner supporting surfaces of the base and the three inner supporting surfaces of the cover body;
a plurality of openings of the two of the three inner supporting surfaces of the base are disposed corresponding to two of four side surfaces of the light combining prism;
a plurality of openings of the two of the three inner supporting surfaces of the cover body are disposed corresponding to other two of the four side surfaces of the light combining prism.

14. The light combining module of claim 10, wherein the light source component comprises:
a heat dissipation layer, attached to the light source panel of the light source component; and
a heat sink, attached to the heat dissipation layer and locked on the panel frame.

15. The light combining module of claim 10, wherein the light source panel is a self-illuminating panel.

16. The light combining module of claim 10, further comprising:
a first elastic element, disposed on the panel frame; and
a light source component fixing cover, wherein the panel frame and the first elastic element are sandwiched between the light source component fixing cover and the positioning component.

17. The light combining module of claim 16, wherein the light source component fixing cover comprises:
a second elastic element, disposed on a first frame edge of the light source component fixing cover;
a third elastic element, disposed on a second frame edge of the light source component fixing cover, wherein the second frame edge is adjacent to the first frame edge;
a plurality of first screws, disposed on a third frame edge of the light source component fixing cover, wherein the third frame edge is located opposite to the first frame edge; and
a plurality of second screws, disposed on a fourth frame edge of the light source component fixing cover, wherein the fourth frame edge is located opposite to the second frame edge.

18. The light combining module of claim 17, wherein a maximum static friction force between the first elastic element and the light source component fixing cover is less than a maximum static friction force between the first elastic element and the panel frame.
